(19) United States
(12) Patent Application Publication
(10) Pub. No.: US 2006/0025292 A1
(43) Pub. Date: Feb. 2, 2006

(54) Producing triple section filters using a dual rod filter maker

(75) Inventors: Douglas R. Hicks, McDonough, GA (US); Rick Gonterman, Macon, GA (US)

Correspondence Address: MIDDLETON & REUTLINGER, 2500 BROWN & WILLIAMSON TOWER, LOUISVILLE, KY, 40202, US

(73) Assignee: BROWN & WILLIAMSON TOBACCO CORPORATION

(21) Appl. No.: 10/901,889

(22) Filed: Jul. 29, 2004

(51) Int. Cl. B31C 13/00

(52) U.S. Cl. 493/39

(57) ABSTRACT

A method of producing a multi-component cigarette filter having one more filter component than the number of hoppers on the machine producing the cigarette filter rods. A dual hopper machine can produce two-component filters as well as three-component filters, and a three hopper machine can produce three-component filters as well as four-component filters.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A “SEQUENTIAL LISTING,” A TABLE, OR A COMPUTER PROGRAM LISTING APPENDIX SUBMITTED ON A COMPACT DISC

Not applicable.

### BACKGROUND OF THE INVENTION

1. Field of the Invention

The present invention relates to cigarette filter rods, and more particularly to a method of producing cigarette filter rods having one more filter rod section than the number of hoppers on a machine producing the cigarette filter rods.

2. Description of the Related Art

Current methods of producing cigarette filter rods require a dual hopper machine to produce two-component rods, a three hopper machine to produce three-component rods, and some combination of dual hopper machines and/or three hopper machines to produce any cigarette filter rod with more than three filter rod components. See U.S. Pat. No. 5,695,441, to Ikura; U.S. Pat. No. 3,357,321, to Hall; and U.S. Pat. No. 3,357,320, to Sextone, et al. Prior methods of forming cigarette filter rods with two or more sections often cut through a charcoal or resin section in a filter, which is costly and unclean, as the charcoal or resin often falls out of the rod and can potentially clog machines or cause contamination, and carbide blades are required to provide equivalent runtime.

A cleaner method of producing multi-component cigarette filter rods having one more section than the number of hoppers on a machine is desired. As such, a multiple hopper machine with X hoppers can conveniently produce either filters with X number of components or X+1 number of components. For example, a dual hopper machine can conveniently produce either two-component filter rods or three-component filter rods, and a three hopper machine can conveniently produce either three-component filters or four-component filters.

### SUMMARY OF THE INVENTION

In view of known deficiencies associated with earlier methods of producing multi-component cigarette filter rods, a method is herein provided to produce multi-component cigarette filter rods having one more section than the number of hoppers on the machine producing the cigarette filter rods. For example, a dual hopper machine can produce two-component filters as well as three-component filters, and a three hopper machine can produce three-component filters as well as four-component filters.

The instant method utilizes existing cigarette filter rod equipment, and only minor modifications are required to produce the new filter rods. A savings in paper plug wrap may be achieved, as well as saving one step in the production, thus reducing conversion costs. The instant method is also advantageous in that any additive material, such as charcoal or selective filtration material or reclaim of tobacco from rejected cigarettes, which, using existing methods, may fall out of the filter rod during cigarette production, is trapped in the center of the filter rod when manufactured via the instant invention. For example, the rotary knife cuts only the fibrous filter material component, such as cellulose acetate, thereby reducing the chance of charcoal, resin, and reclaim fallout, contamination, and machine clogging. As such, the method provides for much cleaner cigarette and filter rod production.

For a better understanding of the present invention, together with other and further objects thereof, reference is made to the following description, taken in conjunction with the accompanying drawings, and its scope will be pointed out in the appending claims.

### BRIEF DESCRIPTION OF THE DRAWINGS

The aspects and advantages of the present invention will be better understood when the detailed description of the preferred embodiment is taken in conjunction with the accompanying drawings, in which:

FIG. 1 is a cross-section of filter components for a cigarette embodiment having a prior art filter configuration processed via a dual hopper machine.

FIG. 2 is a cross-section of filter components for the cigarette embodiment of FIG. 1 including a filter configuration of the present invention processed via a dual hopper machine.

FIG. 3 is a cross-section of filter components for a second cigarette embodiment having a prior art filter configuration processed via a dual hopper machine.

FIG. 4 is a cross-section of filter components for the cigarettes embodiment of FIG. 3 including a filter configuration of the present invention processed via a dual hopper machine.

FIG. 5 is a cross-section of filter components for a third cigarette embodiment having a prior art filter configuration processed via a dual hopper machine.

FIG. 6 is a cross section of filter components for the cigarette embodiment of FIG. 5 including a filter configuration of the present invention processed via a dual hopper machine.

FIG. 7 is a cross section of filter components for a fourth cigarette embodiment having a prior art filter configuration processed via a dual hopper machine.

FIG. 8 is a cross section of filter components for the cigarette embodiment of FIG. 7 including a filter configuration of the present invention processed via a dual hopper machine.

### DETAILED DESCRIPTION OF THE PREFERRED EMBODIMENTS

While this invention is susceptible of embodiments in many different forms, there are shown in the Figures and will herein be described in detail, preferred embodiments of the invention with the understanding that the present disclosure is to be considered as an exemplification of the principles of the invention, and is not intended to limit the broad aspects of the invention to the embodiments illustrated.

The present invention provides a method to produce multi-component cigarette filter rods having one more filter rod section than the number of hoppers on the machine producing the cigarette filter rods. The integrity of the filter component proportions remains the same, while the configuration varies minimally to produce multi-component cigarette filter rods which have one more section than the number of hoppers on the machine producing the cigarette filter rods. Maintaining the integrity of filter components in cigarette filter rods is important because, by varying the length of the various components, such as the cellulose acetate filter plug and the various filter media, and the composition of each of the components, certain aspects of the smoking process, such as the taste, smoke constituent delivery, puff number, and draw ease, will vary.

It is noted that the Figures are not drawn to scale, and the filter configuration can be comprised of any filter media known in the art, such as fibrous filter media (e.g., cellulose acetate) and pourable filter media (e.g., resin or charcoal).

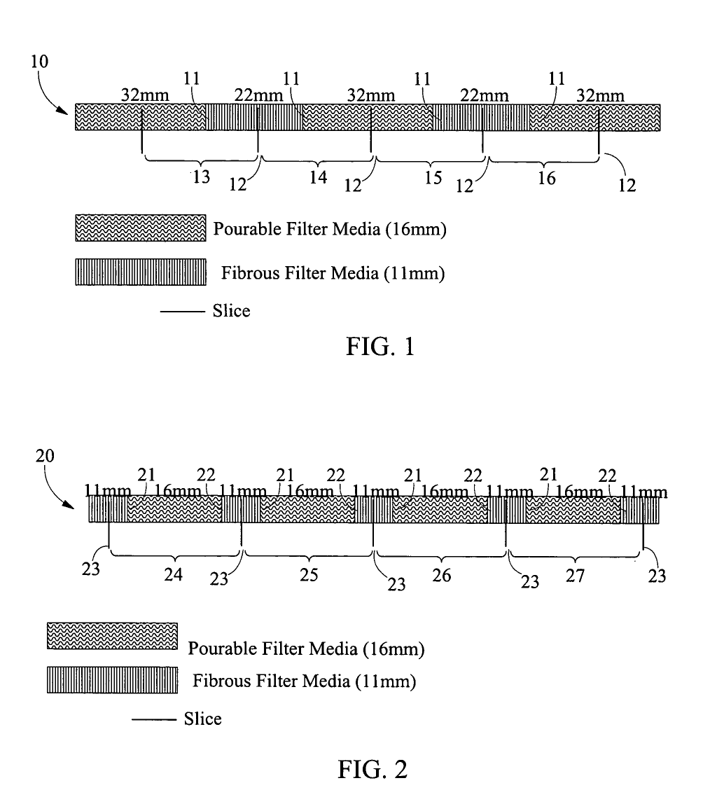

Referring to FIG. 1, there is provided a cross-section of filter components for a cigarette filter rod embodiment 10, usually referred to as milds, having a prior art two-component filter configuration processed via a dual hopper machine. The total filter length for an individual milds cigarette is typically 27 mm. The prior art filter configuration of FIG. 1 shows a “4 up rod,” which is a cigarette filter rod 10 that is cut to make four individual cigarette filters 13, 14, 15, 16, during the cigarette manufacturing process. In this milds cigarette filter embodiment 10, a first filter media component, usually a pourable filter media component (such as for example charcoal or resin media), is 32 mm in length, and a second filter media component, usually a fibrous filter material component (such as for example cellulose acetate), is 22 mm in length, alternate along the cigarette filter rod, for a total of five components. A joint 11 is located between each alternating component. To obtain a milds configuration of 27 mm, via a dual hopper using the prior art method, the cigarette filter rod 10 must receive a slice 12 via a rotary knife halfway through each first filter media component and through each second filter media component, resulting in four individual cigarette filters 13, 14, 15, 16, each having an adjoined 16 mm first filter media component length (half of 32 mm is 16 mm) and 11 mm second filter media component length (half of 22 mm is 11 mm), which total 27 mm (16 mm plus 11 mm is 27 mm).

In the instant invention, a dual hopper machine will not only be able to produce the two component filters as previously described, but also three component cigarette filters 24, 25, 26, 27, as shown in FIG. 2. The method utilizes the existing cigarette filter rod equipment with minor modifications to the milds cigarette filter rods 20. Referring to FIG. 2, there is shown a cross-section of filter components for the milds cigarette filter rod 20 having the new three-component filter configuration using a dual hopper machine. The 27 mm milds configuration is maintained by varying the position of each component of the cigarette filter rod. In such a configuration, the first filter media component is 16 mm in length and the second filter media component is 1 mm in length, which alternate along the cigarette filter rod, for a total of nine components. A first joint 21 and a second joint 22 are now present in each resulting individual cigarette filter 24, 25, 26, 27. The new inventive method provides for a slice 23 with a rotary knife halfway through each 11 mm second filter media component only. The first filter media components are not cut. Referring to FIG. 2, the result is individual cigarette filters 24, 25, 26, 27, each having a first filter media component 16 mm in length positioned between second filter media components 5.5 mm in length (half of 11 mm is 5.5 mm) on each side, separated by the two joints 21, 22. The two 5.5 mm second filter media components, totaling 11 mm, positioned on either side of the 16 mm first filter media component, result in the 27 mm milds cigarette filter configuration 24, 25, 26, 27 (5.5 mm plus 16 mm plus 5.5 mm is 27 mm). The first and last sections of each cigarette filter 24, 25, 26, 27 have the same first filter media component, such as cellulose acetate. The first filter media component and the second filter media component are in a different configuration, but the total amount of the first filter media component and the second filter media component will remain the same; that is, the first filter media component will remain at a length of 16 mm and the second filter media component will remain at a length of 11 mm, as in the original configuration (FIG. 1). The lengths of the components may change if desired, but will most likely stay the same to give similar filter functions as the original filter design.

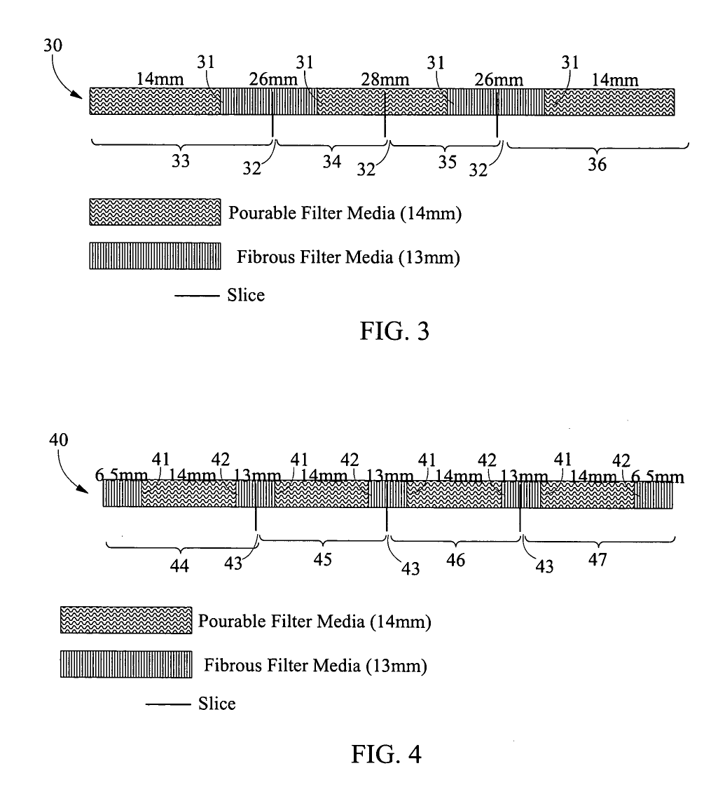

FIGS. 3-8 are for illustrative purposes only, and show that the instant invention could be used to produce any number of varying filter designs, each having one more filter than the number of hoppers on the machine. Additionally, each filter design would have the same filter component at both the mouth end and the tobacco end of the filter. The length and components of the filter rods may change.

Referring now to FIG. 3, there is provided a cross-section of filter components for a cigarette filter rod embodiment 30, usually referred to as milds, having a prior art two-component filter configuration processed via a dual hopper machine. Again, the total filter length for the milds cigarette is typically 27 mm. The prior art filter configuration of FIG. 3 shows a “4 up rod,” which is a cigarette filter rod 30 that is cut to make four individual filters 33, 34, 35, 36, during the cigarette manufacturing process. This milds cigarette filter rod embodiment 30 has a first filter media component, such as a pourable filter media component, 28 mm in length in the middle of the filter rod, a second filter media component, such as a fibrous filter media component 26 mm in length on either side of the pourable filter media component (first filter media component), and the pourable filter media (first filter media component) component 14 mm in length on the outer ends of the filter rod, for a total of five components. A joint 31 is located between each alternating component. To obtain a milds configuration of 27 mm, via a dual hopper machine using a prior art method, the filter rod must receive a slice 32 halfway through the 28 mm-length pourable filter media component (first filter media component) and halfway through each of the fibrous filter media components, resulting in four individual cigarette filters 33, 34, 35, 36, each having an adjoined 14 mm-length pourable filter media component (first filter media component) (half of 28 is 14) and a 13 mm length of fibrous filter media component (half of 26 mm is 13 mm), which total 27 mm (14 mm plus 13 mm is 27 mm).

In the instant invention, a dual hopper machine will not only be able to produce the two component filters as just described, but also three component cigarette filters 44, 45, 46, 47, as shown in FIG. 4. The method utilizes the existing cigarette filter rod equipment with minor modifications to the milds cigarette filter rods 40. Referring to FIG. 4, there is shown a cross-section of filter components for milds cigarettes filter rod 40 having the new three-component filter configuration using a dual hopper machine. The 27 mm-length milds configuration is maintained by varying the position of each component of the cigarette filter rod. In such a configuration, the pourable filter media component (first filter media component) is 14 mm in length and the fibrous filter media component (second filter media component) is 13 mm in length, with 6.5 mm fibrous filter media components (second filter media component) on each end of the cigarette filter rod, for a total of nine components. A first joint 41 and a second joint 42 are now present in each resulting cigarette filter 44, 45, 46, 47. The new inventive method provides for a slice 43 with a rotary knife halfway through each 13 mm length of fibrous filter media component (second filter media component) only. The pourable filter media components (first filter media component) are not cut. Referring to FIG. 4, the result is individual cigarette filters 44, 45, 46, 47, each having a 14 mm length of pourable filter media component (first filter media component) positioned between a 6.5 mm length of fibrous filter media component (second filter media component) (half of 13 mm is 6.5 mm) on each side, separated by the two joints 41, 42. The two 6.5 mm fibrous filter media components (second filter media component), totaling 13 mm, positioned on either side of the 14 mm length of pourable filter media component (first filter media component) results in the 27 mm milds cigarette filter configuration 44, 45, 46, 47 (6.5 mm plus 14 mm plus 6.5 mm is 27 mm). The first and last sections of each cigarette filter 44, 45, 46, 47, have the same fibrous filter media component (second filter media component), such as cellulose acetate. The positions of the pourable filter media components (first filter media component) and the length of the fibrous filter media components (second filter media component) are in a different configuration, but the total amount of the pourable filter media component (first filter media component) and the fibrous filter media component (second filter media component) will preferably remain the same; that is, the pourable filter media component (first filter media component) will remain at 14 mm in length and the fibrous filter media component (second filter media component) will remain at 13 mm in length, as in the original configuration (FIG. 3).

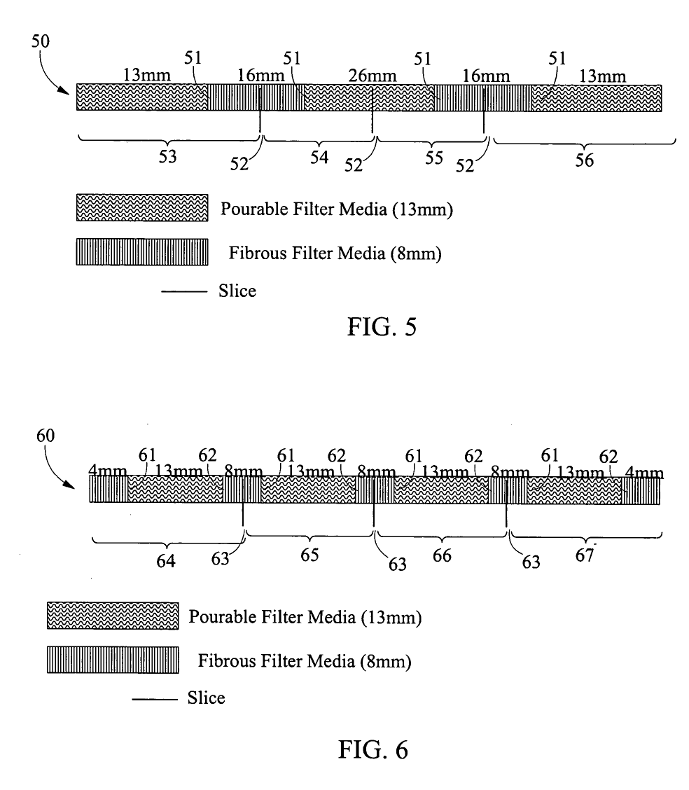

Referring to FIG. 5, there is provided a cross-section of filter components for a cigarette filter rod embodiment 50, usually referred to as full flavor, having a prior art two-component filter configuration processed via a dual hopper machine. The total filter length for a full flavor cigarette is typically 21 mm. The prior art filter configuration of FIG. 5 shows a “4 up rod,” which is a cigarette filter rod 50 that is cut to make four individual filters 53, 54, 55, 56, during the cigarette manufacturing process. In this full flavor cigarette embodiment 50, the pourable filter media component (first filter media component) is 26 mm in length in the middle of the filter rod, has a 16 mm-length of fibrous filter media component on either side (second filter media component), and a 13 mm length of the pourable filter media component (first filter media component) on the outer ends of the filter rod, for a total of five components. A joint 51 is located between each alternating component. To obtain the full flavor configuration of 21 mm in length, via a dual hopper using the prior art method, the filter rod must receive a slice 52 halfway through the 26 mm length of pourable filter media component (first filter media component) and halfway through each of the 16 mm lengths of fibrous filter media components (second filter media component), resulting in four cigarette filters 53, 54, 55, 56, each having an adjoined 13 mm length of pourable filter media component (first filter media component) (half of 26 mm is 13 mm) and 8 mm length of fibrous filter media component (second filter media component) (half of 16 mm is 8 mm), which total 21 mm (13 mm plus 8 mm is 21 mm).

In the instant invention, a dual hopper machine will not only be able to produce the two-component filters as just described, but also three-component filters 64, 65, 66, 67, as shown in FIG. 6. The method utilizes the existing cigarette filter rod equipment with minor modifications to the full flavor cigarette filter rods 60. Referring to FIG. 6, there is shown a cross-section of filter components for full flavor cigarette filter rods 60 having the new three-component filter configuration using a dual hopper machine. The 21 mm-length full flavor configuration is maintained by varying the position of the components of the cigarette filter rod. In such a configuration, the pourable filter media component (first filter media component) is 13 mm in length and the fibrous filter media component (second filter media component) is 8 mm in length, with 4 mm fibrous filter media components (second filter media component) on each end of the cigarette filter rod, for a total of nine components. A first joint 61 and a second joint 62 are now present in each resulting cigarette filter 64, 65, 66, 67. The new inventive method provides for a slice 63 with a rotary knife halfway through each 8 mm fibrous filter media component (second filter media component) only. The pourable filter media component (first filter media component) is not cut. Referring to FIG. 6, the result is individual cigarette filter 64, 65, 66, 67, each having a 13 mm length of pourable filter media component (first filter media component) positioned between a 4 mm length of fibrous filter media component (second filter media component) (half of 8 mm is 4 mm) on each side, separated by the two joints 61, 62. The two 4 mm fibrous filter media components (second filter media component), totaling 8 mm, positioned on either side of the 13 mm pourable filter media components (first filter media component) results in the 21 mm full flavor cigarette filter configuration 64, 65, 66, 67 (4 mm plus 13 mm plus 4 mm is 21 mm). The first and last sections of each cigarette filter 64, 65, 66, 67, preferably have the same fibrous filter media component (second filter media component), such as cellulose acetate. The positions of the pourable filter media components (first filter media component) and the length of the fibrous filter media components (second filter media component) are in a different configuration, but the total amount of the pourable filter material component (first filter media component) and the fibrous filter media component (second filter media component) will remain the same; that is, the pourable filter media component (first filter media component) will remain at 13 mm in length and the fibrous filter media component (second filter media component) will remain at 8 mm in length, as in the original configuration (FIG. 5).

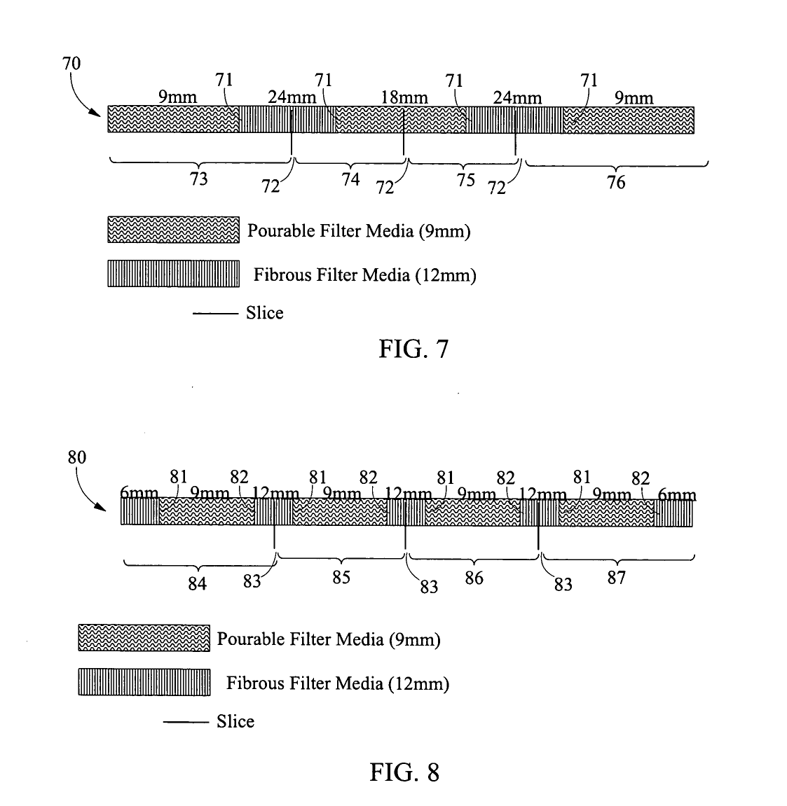

Referring to FIG. 7, there is provided a cross-section of filter components for a cigarette embodiment 70, usually referred to as full flavor, having a prior art two-component filter configuration processed via a dual hopper machine. As previously discussed, the total filter length for a full flavor cigarette is typically 21 mm. The prior art filter configuration of FIG. 7 shows a “4 up rod,” which is a cigarette filter rod that is cut to make four individual filters 73, 74, 75, 76, during the cigarette manufacturing process. In this full flavor cigarette embodiment 70, the pourable filter media component (first filter media component) is 18 mm in length in the middle of the filter rod, has a 24 mm-length of fibrous filter media component (second filter media component) on either side, and 9 mm-length of the pourable filter media component (first filter media component) on the outer ends of the filter rod, for a total of five components. A joint 71 is located between each alternating component. To obtain a full flavor configuration of 21 mm, via a dual hopper using the prior art method, the filter rod receives a slice 72 halfway through the pourable filter media component (first filter media component) and halfway through each of the fibrous filter media components (second filter media component), resulting in four cigarette filters 73, 74, 75, 76, each having an adjoined 9 mm length of pourable filter media component (first filter media component) (half of 18 mm is 9 mm) and a 12 mm length of fibrous filter media component (second filter media component) (half of 24 mm is 12 mm), which total 21 mm (9 mm plus 12 mm is 21 mm).

In the instant invention, a dual hopper machine will not only be able to produce the two-component filters as just described, but also three-component filters 84, 85, 86, 87, as shown in FIG. 8. The method utilizes the existing cigarette filter rod equipment with minor modifications to the cigarette filter rods 80. Referring to FIG. 8, there is shown a cross-section of filter components for full flavor cigarette filter rods 80 having the new three-component filter configuration using a dual hopper machine. The 21 mm-length full flavor configuration is maintained by varying the position of the components of the cigarette filter rod. In such a configuration, the pourable filter media component (first filter media component) is 9 mm in length and the fibrous filter media components (second filter media component) are 12 mm in length, with 6 mm lengths of fibrous filter media components (second filter media component) on each end of the cigarette filter rod, for a total of nine components. A first joint 81 and a second joint 82 are now present in each resulting cigarette filter plug 84, 85, 86, 87. The new method provides for a slice 83 with a rotary knife halfway through each 12 mm fibrous filter media component (second filter media component) only. The pourable filter media components (first filter media component) are not cut. Referring to FIG. 8, the result is four individual cigarette filter plugs 84, 85, 86, 87, each having a 9 mm length of pourable filter media component (first filter media component) positioned between a 6 mm (half of 12 mm is 6 mm) length of fibrous filter media component (second filter media component) on each side, separated by the two joints 81, 82. The two 6 mm fibrous filter media components (second filter media component), totaling 12 mm, positioned on either side of the 9 mm pourable filter media component (first filter media component) results in the 21 mm full flavor cigarette filter configuration 84, 85, 86, 87 (6 mm plus 9 m plus 6 mm is 21 mm). The first and last sections of the cigarette filter 84, 85, 87, 87, have the same fibrous filter media component (second filter media component), such as cellulose acetate. The positions of the pourable filter media components (first filter media component) and the length of the fibrous filter media components (second filter media component) are in a different configuration, but the length will always remain the same; that is, the pourable filter media components (first filter media component) will remain at 9 mm in length and the fibrous filter media components (second filter media component) will remain at 12 mm in length.

The foregoing detailed description is given primarily for clearness of understanding and no unnecessary limitations are to be understood therefrom, for modifications will become obvious to those skilled in the art upon reading this disclosure, and may be made without departing from the spirit of the invention and scope of the appended claims. For example, the configuration of the components of the cigarette filter rod are the essence of the invention. The pourable filter media component (first filter media component) may be charcoal, resin, charcoal and resin, etc. The fibrous material may be cellulose acetate or any other fiber which acts as a filter and is non pourable.

What is claimed is:

1. A method of producing a multi-component cigarette filter, comprising the steps of:
inserting a filter rod into a hopper of a cigarette making machine,
wherein said filter rod is comprised of a plurality of alternating first and second filter media components; and
wherein said second filter media components are positioned at opposing ends of said filter rod; and
slicing said filter rod only through said second filter media components.

2. The method of claim 1, wherein said first filter media components being pourable filter media components and said second filter media components being fibrous filter media components.

3. The method of claim 2, wherein said fibrous filter media components are comprised of cellulose acetate.

4. The method of claim 2, wherein said pourable filter media components are comprised of materials selected from the group consisting of charcoal and resin.

5. The method of claim 1, wherein said second filter media components are shorter in length than said first filter media components.

6. The method of claim 1, wherein said second filter media components are sliced in half.

7. A method of producing a triple-section filter, comprising the steps of:
inserting a filter rod into a dual hopper of a cigarette making machine,
wherein said filter rod is comprised of a plurality of alternating first and second filter media components,
wherein a first joint and a second joint separate said first and second filter media components,
wherein said second filter media components are shorter in length than said first filter media components, and
wherein said second filter media components are positioned at opposing ends of said filter rod; and
slicing said filter rod only through said second filter media components such that said triple section filters results, said triple section filters each having said first filter media component positioned between said second filter media components.

8. The method of claim 7, wherein said first filter media components being pourable filter media components and said second filter media components being fibrous filter media components

9. The method of claim 8, wherein said fibrous filter media components are comprised of cellulose acetate.

10. The method of claim 8, wherein said pourable filter media components are comprised of material selected from the group consisting of charcoal and resin.

11. The method of claim 7, wherein said filter rod has an odd number of said second filter media components and an even number of said first filter media components.

12. The method of claim 11, wherein said filter rod has five second filter media components and four first filter media components.

13. The method of claim 7, wherein said second filter media components are sliced in half, such that all resulting second filter media components are equal in size.

14. A method of making triple-component cigarette filters via a dual hopper machine, comprising the steps of:
inserting a filter rod into said dual hopper machine,
wherein said filter rod is comprised of an odd number of alternating second filter media components and first filter media components and joints separating said second filter media components and said first filter media components,
wherein said second filter media components are shorter in length than said first filter media components, and
wherein said second filter media components are positioned at opposing ends of said filter rod; and
slicing said filter rod only through said second filter media components, such that said triple-component cigarette filters result, said triple-component cigarette filters each having said first filter media components positioned between two of said second filter media components.

15. The method of claim 14, wherein said first filter media components being pourable filter media components and said second filter media components being fibrous filter media components

16. The method of claim 15, wherein said fibrous filter media components are comprised of cellulose acetate.

17. The method of claim 15, wherein said pourable filter media components are comprised of material selected from the group consisting of charcoal and resin.

18. The method of claim 14, wherein said filter rod has an odd number of said second filter media components and an even number of said first filter media components.

19. The method of claim 18, wherein said filter rod has five second filter media components and four first filter media components to form a nine-component filter rod.

20. The method of claim 14, wherein said second filter media components are sliced in half, such that all resulting second filter media components are equal in size.

21. A method of producing an X+1-component smoking article filter, comprising the steps of:
inserting a filter rod into a cigarette-making machine having X hoppers, wherein said filter rod is comprised of an odd number of alternating components, and
slicing every other alternating component.

22. The method of claim 21, wherein said alternating components are first filter media components and second filter media components.

23. The method of claim 22, wherein said first filter media components being pourable filter media components and said second filter media components being fibrous filter media components

24. The method of claim 23, wherein said fibrous filter media components are comprised of cellulose acetate.

25. The method of claim 23, wherein said pourable filter media components are comprised of material selected from the group consisting of charcoal and resin.

26. The method of claim 22, wherein said second filter media components are sliced in half, such that all resulting second filter media components are equal in size and such that said X+1-component smoking article filter results, said X+1-component smoking article filter each having said first filter media component positioned between said second filter media components.

27. The method of claim 22, wherein said second filter media components are shorter in length than said first filter media components.

28. The method of claim 21, wherein joints separate each of said alternating components.
